(19) United States
(12) Patent Application Publication
(10) Pub. No.: US 2026/0161015 A1
(43) Pub. Date: Jun. 11, 2026

(54) Stackable Paddings for Eyeglasses

(71) Applicant: Eben Haezer Saputra, Toronto (CA)

(72) Inventor: Eben Haezer Saputra, Toronto (CA)

(21) Appl. No.: 18/972,930

(22) Filed: Dec. 7, 2024

(51) Int. Cl. G02C 3/00; G02C 5/14; G02C 13/00

(52) U.S. Cl. CPC G02C 3/003; G02C 5/146; G02C 13/001

(57) ABSTRACT

According to an aspect of the present invention, there is provided stackable eyeglasses padding that reduces the frequence and intensity of eyeglasses slipping down, comprising: a padding medium; adhesive; and backing, wherein the padding pieces are applied beside the eyeglasses hinge to prevent the eyeglasses' temple from opening too wide and slipping down.

### CROSS-REFERENCE TO RELATED APPLICATIONS

This application claims the benefit of priority to provisional patent application No. 63/635,617.

### BACKGROUND

This invention relates generally to eyeglasses and more particularly, devices that are used to reduce slippage of eyeglasses.

This invention is related to the following items: removable nosepad sticker and temple tighteners. Removable nosepad stickers are applied to eyeglasses' nosepad area used to prevent glasses from slipping off. This is achieved by increasing the friction between the glasses and the user's nose bridge, by using materials that can act as a cushion and has springy properties, such as silicone or foam. Adhesive is applied to one of the sides of the nosepads so that it can adhere to the eyewear.

Temple tighteners provide an option to reduce glass slip without skin contact. Temple tightener is a ring-shaped object placed at eye glasses hinge to manipulate the angle of the temple of eyeglasses so it presses harder toward user's skin. It is around 2 mm height and made of malleable materials such as silicone, rubber, and latex. For installation, temple tighteners need to be slid down along the glasses' temple.

Nosepad stickers have been a common option to reduce eyeglasses slippage but it can cause discomfort, has short life span, and non-discreet. Nosepad stickers work by adding friction points between eyeglasses and nose bridge. However, the same friction also causes red pressure marks on nose bridge. This friction is also what causes the adhesive on nosepad stickers to wear off within weeks after usage. Towards the end of the lifespan, the nosepad stickers become visibly less hygienic as its weakening glue spread to the periphery and collect dirt and debris.

Another solution, temple tightener, is a ring-shaped rubber designed to be placed on the hinges. While it is relatively discreet, it will cause long term pain due to its typical thickness of 2 mm. Further still, temple tighteners do not allow users to reduce its thickness if it is too tight. In contrast, even a 0.5 mm thick padding is enough to cause pain to the user.

### SUMMARY OF INVENTION

It would be desirable to have eyeglasses slip reduction solution that can last a long time. It would also be desirable for the device to be discreet. Further still, it would be desirable to have the thickness to be adjustable to suit individual need.

Therefore, there currently exist a need in the industry for an eyeglass slip reduction solution that is long-lasting, discreet, and adjustable. Similarly, it would be desirable for this product to be affordable by both utilizing well-known manufacturing techniques and cheap material without compromising the quality.

Disclosed are stackable eyeglasses paddings (FIG. 1) which is composed of small padding pieces spread on top of solid backings (FIG. 2). It is small enough that it can be placed beside eyeglasses hinge (FIG. 3) and act as angle stopper that restrict the eyeglasses temple from opening too wide. Functionally it works similar in the same principle to temple tighteners. It may come in different thickness from 0.01 mm to 0.30 mm and can be easily stacked on top of each other to allow users adjust the thickness they need (FIG. 5). The stackable eyeglasses paddings are placed at area that are free from skin contact, making it long lasting, while its small size and thin profile-almost the width of a human hair-makes it discreet.

Moreover, the stackable eyeglasses paddings can be produced cheaply using common product production method called “kiss cut” (FIG. 5). This allows consistent product quality at reasonable price.

Some variations of the stackable may include rolls of stickers (FIG. 8), non-flat paddings such as but not limited to slanted paddings (FIG. 9), stackable eyeglasses padding with individual backings (FIG. 10), and paddings with textures (FIG. 11).

### BRIEF DESCRIPTION OF THE DRAWINGS

FIG. 1: Top view of the stackable eyeglasses padding

FIG. 2: Side view of the stackable eyeglasses padding

FIG. 3: Application of the padding pieces

FIG. 4: How the padding pieces limit restrict the opening angle of glasses temple

FIG. 5: Perspective view of padding pieces stacked on top of each other.

FIG. 6: Raw material before kiss-cutting

FIG. 7: Kiss-cutting

FIG. 8: Alternative 1—Stackable eyeglasses padding in a roll

FIG. 9: Alternative 2—Non-flat Stackable eyeglasses padding

FIG. 10: Alternative 3—Stackable eyeglasses padding with individual backing

FIG. 11: Alternative 4—Stackable eyeglasses padding with textured padding medium

### DETAILED DESCRIPTION

This invention is stackable eyeglasses paddings that reduces the frequency and intensity of eyeglasses from slipping down. It is applied beside the eyeglasses hinge, preventing the eyeglasses' temple from opening too wide and slipping down. The stackable eyeglass paddings consist of three main components: padding medium, adhesive, and backing.

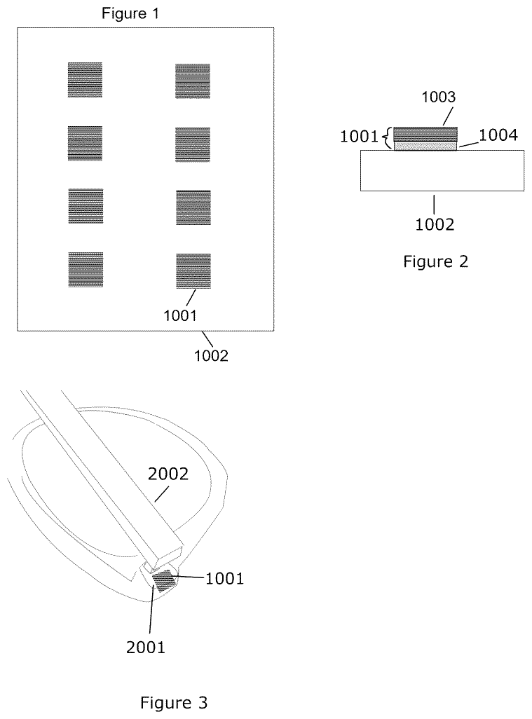

FIG. 1 shows the top view of the stackable eyeglasses padding. Each padding pieces 1001 are placed on top of a backing 1002.

Each padding must have a surface area of at least 9 mm². Smaller areas risk sticking to the cutting machine during production. The maximum thickness of each padding is also limited to 0.3 mm. Exceeding this thickness would cause the eyeglasses to open too narrow and cause pain to the user.

FIG. 2 shows the side view of the stackable eyeglasses padding. Here, it shows padding pieces 1001 are composed of two materials: padding medium 1003 and adhesive 1004. They are both placed on top of a backing 1002.

The backings hold the padding medium and its adhesive before being applied. The backing is made large enough to hold several small individual padding pieces. This is necessary to facilitate easier padding piece removal because each padding piece can be fairly small.

To tailor comfort levels to individual preferences, users may opt for layering multiple padding pieces in stacked configurations. To facilitate this process, additional pads of any thickness can be applied on top of existing ones on the glasses.

FIG. 3 shows the padding pieces 1001 are applied at 2001, beside the hinge of the glasses. The glasses temple 2002 has to be closed for the padding pieces 1001 to be applicable. Notice that there are excess material jutting out at this stage.

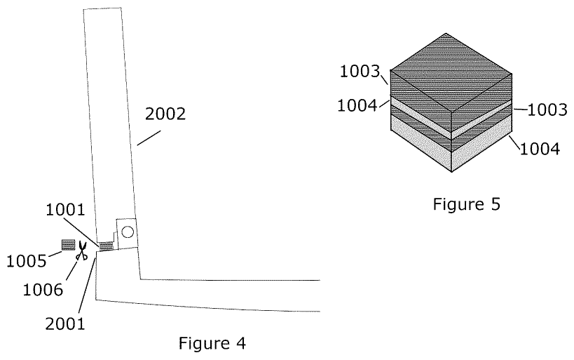

FIG. 4 show the padding pieces 1001 act as an angle stopper for the glasses temple 2002. The padding pieces are nestled at area beside the hinges 2001 and the temple 2002. Excess material 1005 are cut off using clippers 1006 or other similar tools.

To use this product, remove the padding from its backing sheet and apply it to an area beside the glasses hinge. The area must be a minimum of 3 mm² to ensure proper adhesion. Once applied, open the eyeglasses temple as wide as possible so the paddings are firmly pinched between the temple and endpieces. Remove excess materials using desired cutting tools.

FIG. 5 shows two padding pieces stacked on top of each other. It can then be applied at the same spot as normal padding pieces, referring to FIG. 3.

The padding medium determine the thickness of the padding and changes how wide the eyeglass hinges can open. The padding medium utilizes materials such as vinyl that effectively hold adhesive while remaining pliable enough to conform to non-flat surfaces. If the material is too rigid, such as PET, the padding cannot adhere to the contour and will eventually slide out.

The adhesive is used to bond the padding medium with the spectacle frame. To facilitate user customization without causing inconvenience during removal, it is essential that the adhesive can be repositioned. This allows users to experiment with different configurations until they find a suitable fit.

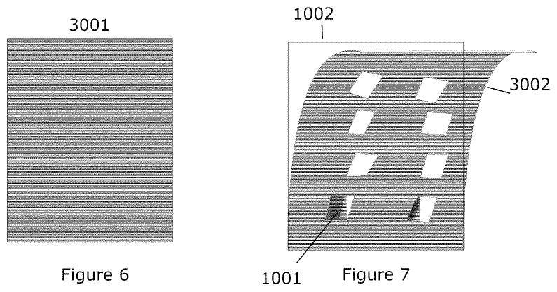

FIG. 6 shows the raw material of stackable eyeglasses padding 3001 before it is processed via kiss cut.

The paddings can be produced using the kiss-cutting method, a common technique employed in sticker manufacturing. This process involves cutting through both the material and adhesive layers while preserving the integrity of the backing sheet. To achieve this, a composite layer consisting of padding medium, adhesive, and backing sheet is fed into the cutting machine. The machine then precision-cuts patterns onto the padding medium and adhesive without severing or damaging the underlying backing sheet. Excess materials are subsequently removed, leaving individual pads intact on their respective backing sheets.

FIG. 7 shows the kiss cut process, where patterns are cut and excess materials 3002 are lifted away. The result are padding pieces 1001 scattered on the backing pieces.

The invention may also have some variations: 1) The paddings including backing sheets can be packed into a continuous roll similar to common tapes available on the market. 2) Separate padding pieces can be created by having their backings fully cut. 3) The padding medium may adopt non-flat surface such as angles or ridges to alter the pressure distribution of the glasses. 4) Lastly, the texture of the padding may be changed to increase friction between the padding and the glasses.

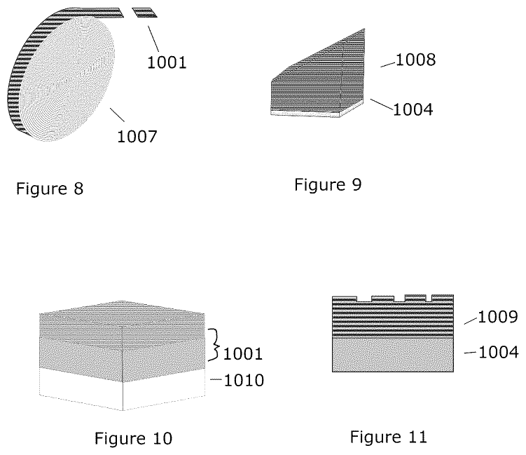

FIG. 8 shows an alternative form where padding pieces are formed into a roll 1007 similar to common commercial tapes.

FIG. 9 shows an alternative where the padding medium has non-flat surface 1008. It is placed on top of an adhesive 1004.

FIG. 10 shows an alternative where each padding pieces 1001 have their own backing 1010. This is in contrast to FIG. 1 where multiple padding pieces share a large backing sheet

FIG. 11 shows an alternative where the padding medium 1009 are textured instead of flat. It is placed on top of adhesive 1004.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A stackable eyeglasses padding that reduces the frequence and intensity of eyeglasses slipping down, comprising:
a padding medium;
adhesive; and
backing,
wherein the paddings are applied beside the eyeglasses hinge to prevent the eyeglasses' temple from opening too wide and slipping down.

2. The stackable eyeglasses padding of claim 1, wherein the stackable eyeglasses padding is composed of small singular stickers with adhesive spread on top of solid backings.

3. The stackable eyeglasses padding of claim 1, wherein the stackable eyeglasses padding is produced using the kiss-cutting method.

4. The stackable eyeglasses padding of claim 1, further comprising layering multiple padding pieces in stacked configurations.

5. The stackable eyeglasses padding of claim 1, wherein padding pieces are formed into a roll similar to common commercial tapes.

6. The stackable eyeglasses padding of claim 1, wherein the padding medium has a non-flat surface.

7. The stackable eyeglasses padding of claim 1, wherein each padding piece has its own backing.

8. The stackable eyeglasses padding of claim 1, wherein multiple padding pieces share a large backing sheet.

9. The stackable eyeglasses padding of claim 1, wherein the padding medium is textured.

10. The stackable eyeglasses padding of claim 1, wherein the padding medium is flat.

11. The stackable eyeglasses padding of claim 1, wherein the padding medium utilizes materials substantially similar to vinyl.

12. The stackable eyeglasses padding of claim 1, wherein each padding has a surface area of at least 9 mm².

13. The stackable eyeglasses padding of claim 1, wherein the maximum thickness of each padding is limited to 0.3 mm.

14. The stackable eyeglasses padding of claim 1, wherein multiple padding pieces share a large backing sheet.

15. The stackable eyeglasses padding of claim 1, wherein the padding pieces act as an angle stopper for the glasses temple.

16. The stackable eyeglasses padding of claim 1, wherein the padding pieces are nestled at an area beside the hinges and the temple.

17. A method of using a stackable eyeglasses padding, comprising:
removing the padding from its backing sheet;
applying it to an area beside the glasses hinge; and
once applied, opening the eyeglasses temple as wide as possible so the paddings are firmly pinched between the temple and endpieces.

18. The method of claim 17, wherein the area is a minimum of 3 mm² to ensure proper adhesion.

19. The method of claim 17, further comprising removing excess materials.

20. The method of claim 19, where the excess material are removed using cutting tools.
